(19) United States
(12) Patent Application Publication
(10) Pub. No.: US 2012/0013473 A1
(43) Pub. Date: Jan. 19, 2012

(54) HDMI DETECTING DEVICE

(75) Inventor: YEN CHANG HUANG, TAIPEI HSIEN (TW)

(73) Assignee: HOBBES & CO., LTD., TAIPEI HSIEN (TW)

(21) Appl. No.: 12/835,096

(22) Filed: Jul. 13, 2010

(51) Int. Cl. G08B 21/00

(52) U.S. Cl. 340/635

(57) ABSTRACT

The instant disclosure relates to a detecting device for diagnosing the connector pins of a HDMI cable. The device includes a housing unit, a detector component, and a power component. The housing has a receiving compartment within. The detecting component is partially received in the receiving compartment of the housing. The detector component includes a detector circuit board, two input-signal sockets, a detector switch, a plurality of signal-status indicators, and a detector directive indicator. The two input-signal sockets, the detector switch, the signal-status indicators and the detector directive indicator electrically connect the detecting circuit board and substantially reveal on a surface of the housing. The power component is received in the receiving compartment of the housing and electrically connected to the detecting component. The two ends of the HDMI cable plug into the two sockets respectively; the detecting circuit board detects an electrical signal between two ends of each pin of the HDMI cable, and the signal-status indicators correspond to the electrical signals of the pins in a one-to-one manner.

### BACKGROUND OF THE INVENTION

1. Field of the Invention

The present invention relates to an HDMI detecting device, in particular, to an HDMI detecting device applied to a HDMI cable, for detecting a plurality of pins of the HDMI cable.

2. Description of Related Art

High definition multimedia interface (HDMI) is now a standard on most TVs, media players, game players, and cameras. One single HDMI cable can support Multichannel digital audio and all the current audio formats, which, includes the standard, enhanced, and high-definition videos. Thus, the HDMI is becoming a widely used multimedia interface.

The HDMI connector has 19 pins and a ground pin. A conventional detecting device treats each three pins of the HDMI connector as one group. When the conventional detecting device is coupled to the HDMI connector during diagnostics, the detector can only exam the connection among a group of pins. Thus, only a short circuit among the pins in a single group can be found. The short connection among the pins from different groups can not be detected. Therefore, the conventional detector often gives incorrect results of detection.

### SUMMARY OF THE INVENTION

In view of the aforementioned issues, an HDMI detecting device is disclosed. The defects in a HDMI cable would be easily detected in accordance with an onboard detector directive indicator. The quality of the HDMI cable pins would be easily determined in accordance with the signal-status indicator.

To achieve the above-mentioned objectives, the present invention provides a detecting device applied to an HDMI cable, for detecting a plurality of pins of the HDMI cable, includes a housing, a detecting component and a power component. The housing defines a receiving compartment within an interior thereof. The detecting component is received in the receiving compartment of the housing; the detecting component includes a detecting circuit board, two input-signal sockets, a detector switch, a plurality of signal-status indicators, and a detector directive indicator; the two input-signal sockets, the detector switch, the signal-status indicators and the detector directive indicator electrically connect the detecting circuit board and substantially reveal on a surface of the housing. The power component is received in the receiving compartment of the housing and electrically connected to the detecting component. The two ends of the HDMI cable plug into the two sockets respectively; the detecting circuit board detects an electrical signal between two ends of each pin of the HDMI cable, and the signal-status indicators correspond to the electrical signals of the pins in an one-on-one manner.

It is worth mentioning that there are some advantages as follows: first, two ends of the cable plugs into the two input-signal sockets respectively, The defective quality of HDMI cable would be judged in accordance with the detector directive indicator. Second, the signal-status indicators correspond to the electrical signals of the pins in a one-on-one manner. The status of the pins of HDMI cable, such as open, short or miss wire, and could be determined quickly by the open indicator, the short indicator, and the miss-wire indicator. The cause regarding the status of the pins could be checked according to the detector directive indicator for fast detects and maintains.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a perspective view of an HDMI detecting device according to the present invention;

FIG. 2 is a front view of the HDMI detecting device according to the present invention;

FIG. 3 is a decomposition view of the HDMI detecting device according to the present invention;

FIG. 4 is a decomposition view from another angle according to the present invention; and

FIG. 5 is a perspective view illustrating the HDMI detecting device connected with an HDMI cable according to the present invention.

### DETAILED DESCRIPTION OF THE PREFERRED EMBODIMENTS

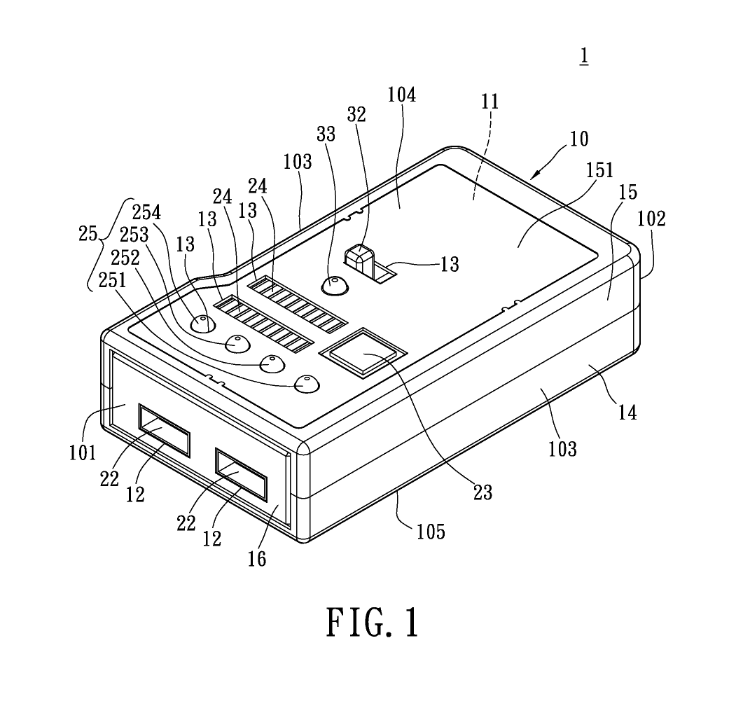

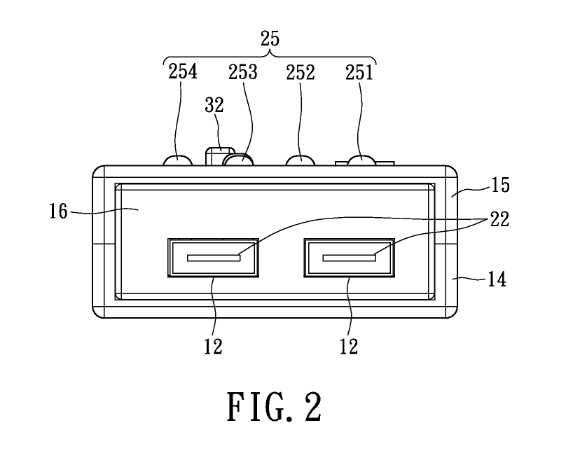

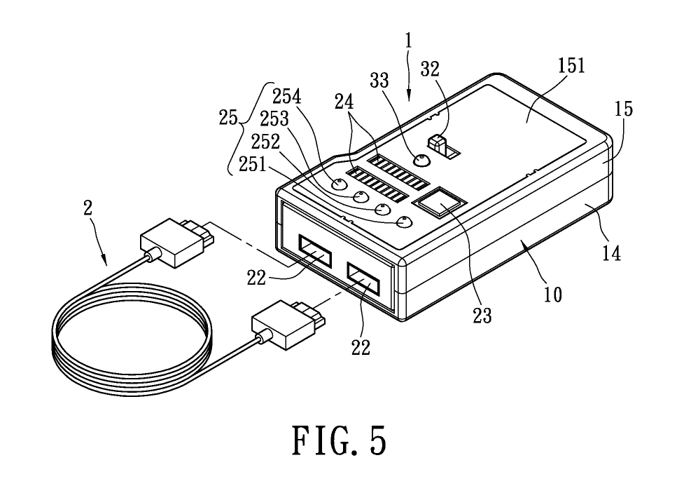

Referring now to FIGS. 1 to 5, which show an HDMI detecting device 1 for coupling to a HDMI cable 2 to diagnose the pins (not shown) of the HDMI cable 2. The detecting device includes a housing 10, a detecting component 20 and a power component 30.

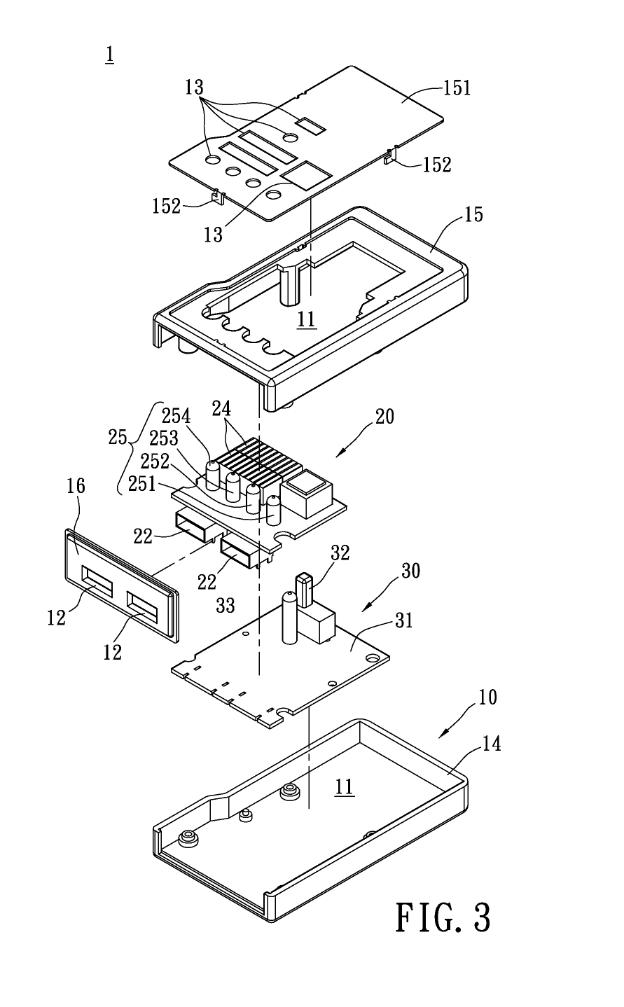

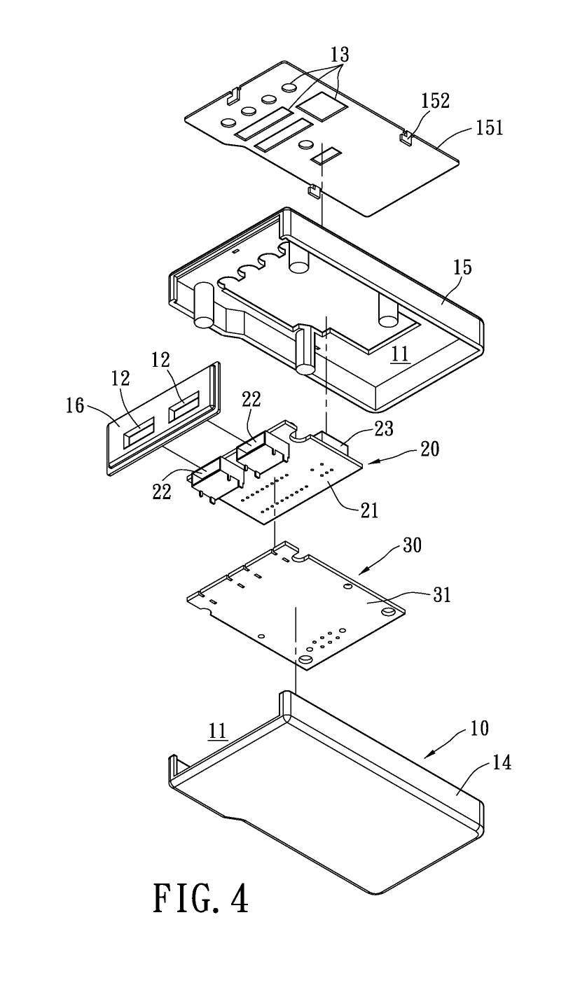

The housing 10 has a front end face 101, a rear end face 102 opposite to the front end face, two lateral faces 103 connecting the front end face and the rear end face, a top face 104 connecting the front end face and the two lateral faces, and a bottom face 105 opposite to the top face 104. The housing 10 has a receiving compartment 11 within for receiving the detector component 20 and the power component 30. The front end face 101 of the housing 10 has two connector holes 12. The top face 104 of the housing 10 has a plurality of openings 13. Referring to FIGS. 3 and 4, the housing 10 includes a base 14, and a top lid 15 and a shuffle board 16 detachably connected to the base 14. The peripheral of the shuffle board 16 joins the top lid 15 and the base 14. The side walls of top lid 15 and the shuffle board 16 jointly define the receiving compartment 11. The top lid 15 further includes a panel 151 having a plurality of buckling portions 152 arranged at a peripheral thereof. The buckling portions 152 are designed to engage with the top lid 15. The housing 10 is designed for the ease of handling single-handedly, providing the operator portability, easy handling and fast maintenance.

The detecting component 20 is received in the receiving compartment 11 of the housing 10. The detecting component 20 includes a detecting circuit board 21, two input-signal sockets 22, a detector switch 23, a plurality of signal-status indicators 24, and a detecting directive indicator 25. The two input-signal sockets 22, the detector switch 23, the signal-status indicators 24, and the detector directive indicator 25 are electrically connected to the detecting circuit board 21. The circuit board 21 determines the electrical signal between the two input-signal sockets 22 (such as conductive, open, shorting or miss-line signal) and correspondingly displays the detection results using the signal-status indicators 24 and the detector directive indicator 25. Furthermore, the two input-signal sockets 22, the detector switch 23, the signal-status indicators 24, and the detector directive indicator 25 are partially reveal on the surface of the housing 10. The two input-signal sockets 22 corresponding to the two connector holes respectively expose out of the front end face 101 of the housing 10. The detector switch 23, the detector directive indicator 25, and the signal-status indicators 24 are arranged to match the openings 103 on the top face 104 for surface exposure.

Referring FIGS. 3 and 4, the detector switch 23, the detector directive indicator 25 and the signal-status indicators 24 are arranged on a face of the detecting circuit board 21, and the two input-signal sockets 22 are arranged on another face of the detecting circuit board 21. The detector switch 23, the detector directive indicator 25, and the signal-status indicators 24 are partially exposed out of the openings 13. The two input-signal sockets 22 are exposed out of the two connector holes 12. In the present example, there are twenty signal-status indicators 24 that correspond respectively to each of the twenty pins of the HDMI cable. The number of the detector directive indicator 25 is not limited, but should include a conductive indicator 251, an open indicator 252, a short indicator 253 and a miss-wire indicator 254. In the present embodiment, the conductive indicator 251 is a green light; the open indicator 252, the short indicator 253 and the miss-wire indicator 254 are red lights. Therefore, operators can determine whether a HDMI cable 2 is defective by consulting the green and red lights of the detector directive indicator 25, thus speeding up the detection process.

In addition, the HDMI detecting device 1 further includes a sound effect device (not shown) connecting to the detector directive indicator 25. The sound effect device 25 could be designed to make more than 2 kinds of noises corresponding to the green/red light status of the detector directive indicator 25, thus further accelerating the detection process.

The power component 30 is received in the receiving compartment 11 of the housing 10 and electrically connected to the detecting component 20. The power component 30 includes a power-saving circuit board 31, a power switch 32 and an electricity quantity indicator 33. The power switch 32 and the electricity quantity indicator 33 electrically connect the power-saving circuit board 31, and extend toward the top face 104 of the housing 10 and expose out of the top face 104 of the housing 10. When the power switch 32 is turned on, the power-saving circuit board 31 is to provide the power source for supporting the detecting component 20, and the electricity quantity indicator 33 is to demonstrate the quantity of electricity of the power-saving circuit board 31.

In use, two ends of the HDMI cable 2 respectively insert into the two input-signal sockets 22, and two ends of each pin electrically connect to the two input-signal sockets 22 one on one, so that the detecting circuit board 21 provides the detecting signals (such as conductive, open, shorting and miss line) between two ends of each pins. When the conductive signal is detected, the detecting circuit board 21 drive to light up the conductive indicator 251, so as to confirm the pins of the HDMI cable meet the standard and the HDMI cable is a good quality product thereby. In the same way, the open, short or miss-line signal is detected, the detecting circuit board 21 drive to light up the open indicator 252, the short indicator 253 and the miss-wire indicator 254, so as to confirm the HDMI cable is a defective item. Consequentially, which light of the detector directive indicator 25 shows helps the operators make a fast determination to confirm the HDMI cable is good or poor.

Moreover, since the signal-status indicators 24 correspond to the pins in a one-on-one manner, and the quality status of each pin would be confirmed quickly by the open indicator 252, the short indicator 253 and the miss-line indicator 254. It makes a short check for operator and also provides a clear confirmation to offer time saving.

It is worth mentioning that there are advantages below:

First, two ends of the HDMI cable 2 plugs into the two input-signal sockets 22 respectively brings fast check of the HDMI cable 2, which is qualified or fail.

Second, the signal-status indicators 24 correspond to the electrical signals of the pins in a one-on-one manner. Thus, the status of the pins of HDMI cable 2 (such as open, shorting, or miss wire) would be determined by the open indicator 252, the short indicator 253 and the miss-wire indicator 254. The cause regarding the status of the pins could be checked according to the detector directive indicator 25 for fast detects and maintains.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A detecting device applied to a HDMI cable, for detecting a plurality of pins of the HDMI cable, comprising:
a housing having a receiving compartment;
a detector component received in the receiving compartment of the housing, the detecting component including a detector circuit board, two input-signal sockets, a detector switch, a plurality of signal-status indicators, and a detector directive indicator; wherein the two input-signal sockets, the detect switch, the signal-status indicators and the detector directive indicator are electrically connected to the detector circuit board and partially revealed on a surface of the housing; and
a power component received in the receiving compartment of the housing and electrically connected to the detector component;
whereby when the two ends of the HDMI cable are plugged into the two sockets, the detect circuit board detects an electrical signal between the pins of the HDMI cable, and the signal-status indicators responds to the electrical signals in an one-to-one manner.

2. The detecting device according to claim 1, wherein the detector directive indicator includes a conductive indicator, an open indicator, a shorting indicator and a miss-wire indicator.

3. The detecting device according to claim 2, wherein the number of the signal-status indicators is 20.

4. The detecting device according to claim 1, wherein the housing defines a front end face, a rear end face opposite to the front end face, two lateral end faces connecting the front end face and the rear end face, a top face connecting the front end face and the two lateral end faces, a bottom face opposite to the top face; the front end face defines two connector holes formed thereof, the top face defines a plurality of openings formed thereof, the two connector holes correspond to the two input-signal sockets thereof respectively for exposing out of the front end face of the housing; the openings correspond to the detector switch, the detector directive indicator and the signal-status indicators for exposing out of the top face of the housing.

5. The detecting device according to claim 4, wherein the detector switch, the detector directive indicator and the signal-status indicators are arranged on a face of the detecting circuit board, the two input-signal sockets are arranged on another face of the detecting circuit board; the detector switch, the detector directive indicator and the signal-status indicators extend toward the openings respectively; the two input-signal sockets extend toward the two connector holes respectively.

6. The detecting device according to claim 5, wherein the power component includes a power-saving circuit board, a power switch and a electricity quantity indicator; the power switch and the electricity quantity indicator electrically connect the power-saving circuit board, and extend toward the top face of the housing and expose out of the top face of the housing.

7. The detecting device according to claim 6, wherein the housing includes a base, and a top lid and a shuffle board detachably connected to the base; a peripheral of the shuffle board connects the top lid and the base; the receiving compartment is defined together by the base, the top lid and the shuffle board.

8. The detecting device according to claim 7, wherein the top lid further includes a panel, which has a plurality of buckling portions arranged at a peripheral thereof; the buckling portions clamp to engage with the top lid.
